(19) United States
(12) Patent Application Publication
(10) Pub. No.: US 2016/0294042 A1
(43) Pub. Date: Oct. 6, 2016

(54) LOOP-SHAPED ANTENNA AND MOBILE TERMINAL

(71) Applicant: HUAWEI DEVICE CO., LTD., Shenzhen, Guangdong (CN)

(72) Inventors: Hanyang WANG, Shenzhen (CN); Bo MENG, Shenzhen (CN)

(21) Appl. No.: 15/037,290

(22) PCT Filed: Dec. 31, 2013
(86) PCT No.: PCT/CN2013/091195

§ 371 Date: May 17, 2016

(51) Int. Cl. H01Q 1/24; H01Q 1/48; H01Q 7/00

(52) U.S. Cl. CPC H01Q 1/243; H01Q 7/00; H01Q 1/48

(57) ABSTRACT

A loop-shaped antenna is disposed in a mobile terminal, where the mobile terminal includes a metal back cover at least partially covers the loop-shaped antenna; the loop-shaped antenna includes a feeding matching circuit, a grounding circuit, and a radiation portion, where the radiation portion is connected between the feeding matching circuit and the grounding circuit, and the radiation portion is of a symmetrical loop-shaped structure; the grounding circuit includes a switch component and a inductor, where the switch component and the inductor are connected in parallel and between ground and the radiation portion; the feeding matching circuit includes a feeding end and a variable capacitor, where the variable capacitor is connected between the feeding end and the radiation portion; and the feeding matching circuit is configured to adjust impedance matching of the loop-shaped antenna, and the grounding circuit is configured to adjust a resonance frequency of the loop-shaped antenna.

### TECHNICAL FIELD

The present invention relates to the field of wireless communications technologies, and in particular, to a loop-shaped antenna and a mobile terminal that includes the loop-shaped antenna.

### BACKGROUND

A mobile terminal is becoming thinner, metal is increasing, and a frequency band is becoming more intensive. All the trends pose a great challenge on antenna design. Generally, an antenna needs to be disposed at a position of a back cover of the mobile terminal, and if the antenna is covered by a metal cover, efficiency of the antenna may be attenuated. In the prior art, a metal-ceramic back cover is used, and performance of the antenna is ensured by covering the antenna with ceramic materials. Design of an antenna for a mobile terminal that has an all-metal back cover is extremely difficult, and currently there is no better solution.

Therefore, to design an antenna applied to a mobile terminal that includes an all-metal cover is a requirement of development in the art.

### SUMMARY

Embodiments of the present invention provide a loop-shaped antenna and a mobile terminal, and the provided loop-shaped antenna can be applied to a mobile terminal that includes an all-metal cover.

According to one aspect, the present invention provides a loop-shaped antenna, disposed in a mobile terminal, where the mobile terminal includes a metal back cover, and the metal back cover covers or partially covers the loop-shaped antenna; the loop-shaped antenna includes a feeding matching circuit, a grounding circuit, and a radiation portion, where the radiation portion is connected between the feeding matching circuit and the grounding circuit, and the radiation portion is of a symmetrical or approximately symmetrical loop-shaped structure; the grounding circuit includes a switch component and a first inductor, where after the switch component and the first inductor connected in parallel and then are connected between a ground and the radiation portion; the feeding matching circuit includes a feeding end and a variable capacitor, where the variable capacitor is connected between the feeding end and the radiation portion; and the feeding matching circuit is configured to adjust impedance matching of the loop-shaped antenna, and the grounding circuit is configured to adjust a resonance frequency of the loop-shaped antenna.

The feeding matching circuit further includes a second inductor and a third inductor, where the second inductor is connected between the feeding end and the variable capacitor, and the third inductor is connected between the variable capacitor and the ground.

The mobile terminal includes a circuit board, and the feeding matching circuit and the grounding circuit are arranged on the circuit board.

The feeding matching circuit and the grounding circuit are disposed, side by side, on a position close to an edge of the circuit board.

The metal back cover is electrically connected to a ground of the circuit board.

The radiation portion is of a three-dimensional structure and includes a first radiation section, a second radiation section, a third radiation section, a fourth radiation section, and a fifth radiation section, where the first radiation section, the second radiation section, the third radiation section, the fourth radiation section, and the fifth radiation section are successively connected in a sequence; the mobile terminal includes a bottom surface, a pair of side surfaces, and a front surface, and the mobile terminal is of a hexahedron structure, where the front surface is configured to dispose a screen of the mobile terminal; the bottom surface is connected between the front surface and the metal back cover; the pair of side surfaces are separately located on two sides of the bottom surface and are connected between the front surface and the metal back cover; the first radiation section and the fifth radiation section have a same structure, and are located on the bottom surface of the mobile terminal; the second radiation section and the fourth radiation section are separately located on the pair of side surfaces; and the third radiation section is located on the front surface of the mobile terminal.

The radiation portion is formed on an insulation medium, where the insulation medium is fixed on a housing of the mobile terminal, the insulation medium is of a cuboid structure or of a polyhedron structure of a similar shape, and the radiation portion extends on four adjacent end faces of the insulation medium.

According to another aspect, the present invention further provides a mobile terminal that includes a metal back cover and a loop-shaped antenna, where the metal back cover covers or partially covers the loop-shaped antenna, and the loop-shaped antenna includes a feeding matching circuit, a grounding circuit, and a radiation portion, where the radiation portion is connected between the feeding matching circuit and the grounding circuit, and the radiation portion is of a symmetrical or approximately symmetrical loop-shaped structure; the grounding circuit includes a switch component and a first inductor, where the switch component and the first inductor are connected in parallel and between a ground and the radiation portion; the feeding matching circuit includes a feeding end and a variable capacitor, where the variable capacitor is connected between the feeding end and the radiation portion; and the feeding matching circuit is configured to adjust impedance matching of the loop-shaped antenna, and the grounding circuit is configured to adjust a resonance frequency of the loop-shaped antenna.

The feeding matching circuit further includes a second inductor and a third inductor, where the second inductor is connected between the feeding end and the variable capacitor, and the third inductor is connected between the variable capacitor and the ground.

The mobile terminal further includes a circuit board, and the feeding matching circuit and the grounding circuit are arranged on the circuit board.

The feeding matching circuit and the grounding circuit are disposed, side by side, on a position close to an edge of the circuit board.

The metal back cover is electrically connected to a ground of the circuit board.

The radiation portion is of a three-dimensional structure and includes a first radiation section, a second radiation section, a third radiation section, a fourth radiation section, and a fifth radiation section, where the first radiation section, the second radiation section, the third radiation section, the fourth radiation section, and the fifth radiation section are successively connected in a sequence; the mobile terminal includes a bottom surface, a pair of side surfaces, and a front surface, and the mobile terminal is of a hexahedron structure, where the front surface is configured to dispose a screen of the mobile terminal; the bottom surface is connected between the front surface and the metal back cover; the pair of side surfaces are separately located on two sides of the bottom surface and are connected between the front surface and the metal back cover; the first radiation section and the fifth radiation section have a same structure, and are located on the bottom surface of the mobile terminal; the second radiation section and the fourth radiation section are separately located on the pair of side surfaces; and the third radiation section is located on the front surface of the mobile terminal.

The radiation portion is formed on an insulation medium, where the insulation medium is fixed on a housing of the mobile terminal, the insulation medium is of a cuboid structure or of a polyhedron structure of a similar shape, and the radiation portion extends on four adjacent end faces of the insulation medium.

Compared with the prior art, in the loop-shaped antenna and the mobile terminal provided in the present invention, the mobile terminal includes a metal back cover, and the metal back cover covers or partially covers the loop-shaped antenna. By using configuration of the loop-shaped antenna, it can be ensured that on a basis on which an all-metal back cover is used by the mobile terminal, the loop-shaped antenna of the mobile terminal can still perform coverage of full-frequency bandwidth of LTE and has good radiation efficiency.

### BRIEF DESCRIPTION OF DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a mobile terminal according to an implementation manner of the present invention;

FIG. 2 is a schematic diagram of a position relationship between a circuit board in a mobile terminal, a loop-shaped antenna, and a metal back cover according to the present invention;

FIG. 3 is a schematic diagram of a radiation portion of a loop-shaped antenna according to an implementation manner of the present invention;

FIG. 4 is a schematic diagram of a radiation portion of a loop-shaped antenna according to an implementation manner of the present invention;

FIG. 5 is a schematic plane diagram of a loop-shaped antenna according to an implementation manner of the present invention;

FIG. 6 is a diagram of a relationship between a frequency and a reflection coefficient of a loop-shaped antenna; and

FIG. 7 is a diagram of a relationship between a frequency and a radiation efficiency of a loop-shaped antenna.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

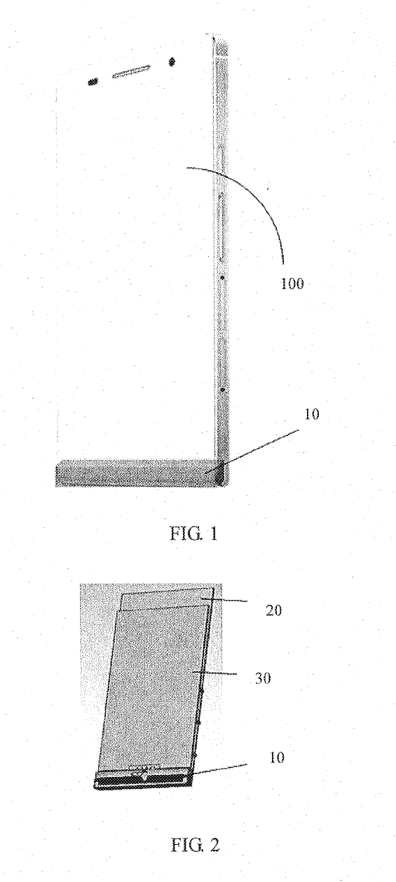

Referring to FIG. 1 and FIG. 2, the present invention provides a mobile terminal 100 and a loop-shaped antenna 10, and the mobile terminal 100 may be an electronic apparatus, such as a mobile phone, a tablet computer, or a personal digital assistant. The mobile terminal 100 of the present invention includes a metal back cover 20, where the metal back cover 20 is all made of a metal material, and covers, in an integrated structure, a back surface of the mobile terminal 100 or partially covers the back surface of the mobile terminal 100. The loop-shaped antenna 10 of the present invention is located at a front end face of a bottom part of the mobile terminal 100, that is, at an edge position of a surface, at which a display screen is located, of the mobile terminal 100. Therefore, the metal back cover 20 covers or partially covers the loop-shaped antenna 10, that is, a vertical projection that is of the loop-shaped antenna 10 and is on the metal back cover 20 falls into a range of the metal back cover 20, so that it is implemented that an all-metal or partial metal back cover 20 is used on the mobile terminal 100.

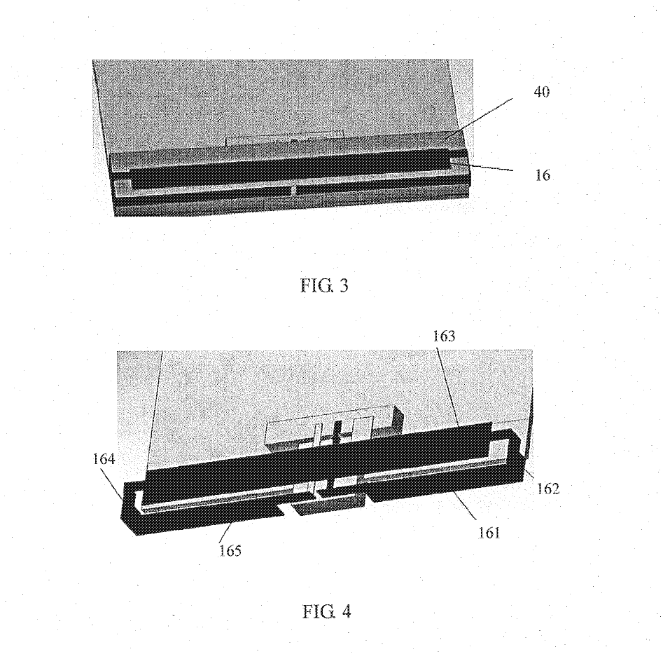

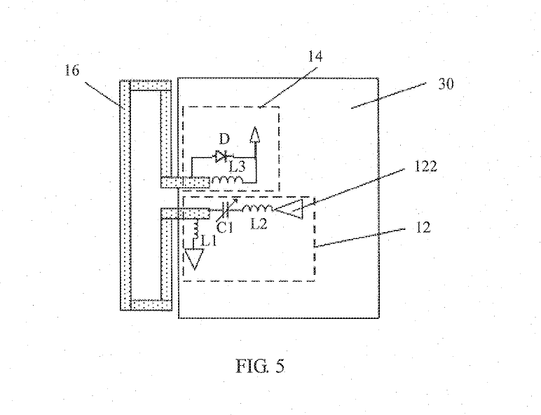

Referring to FIG. 3, FIG. 4, and FIG. 5, the loop-shaped antenna 10 includes a feeding matching circuit 12, a grounding circuit 14, and a radiation portion 16, where the radiation portion 16 is connected between the feeding matching circuit 12 and the grounding circuit 14, and the radiation portion 16 is of a symmetrical or approximately symmetrical loop-shaped structure; the grounding circuit 14 includes a switch component D and a first inductor L3, where the switch component D and first inductor L3 are connected in parallel and between a ground and the radiation portion 16; the feeding matching circuit 12 includes a feeding end 122 and a variable capacitor C1, where the variable capacitor C1 is connected between the feeding end 122 and the radiation portion 16; and the feeding matching circuit 12 is configured to adjust impedance matching of the loop-shaped antenna 10, and the grounding circuit 14 is configured to adjust a resonance frequency of the loop-shaped antenna 10. In an implementation manner, the switch component D is a diode or an electrically controlled switch.

A current flows from an end of the feeding matching circuit 12 to the loop-shaped antenna 10. Therefore, the end of the feeding matching circuit 12 has a relatively large current. A lowest mode of the loop-shaped antenna 10 covers a low LTE frequency band of the antenna, and a process in which a current passes through the radiation portion 16 is as follows: The current gradually decreases until the current becomes zero, and then the current gradually increases; when the current flows from the radiation portion 16 to the grounding circuit 14, the current becomes larger, and a relatively large grounding current is obtained. Because the radiation portion 16 is of a symmetrical or approximately symmetrical loop-shaped structure, the current at a center position of the radiation portion 16 is zero. Therefore, a length of low-frequency resonance of the loop-shaped antenna 10 of the present invention is a half wavelength; a radiation diameter of a relatively commonly used IFA, PIFA, or Monopole antenna (an antenna with a quarter wavelength) is large, and efficiency of low-frequency radiation is high. Higher order modes of the loop-shaped antenna 10 include a one wavelength resonance mode, a one half wavelength resonance mode, a two wavelengths resonance mode, a two wavelengths and one half wavelength resonance mode, and the like, which can cover a high LTE frequency band of the antenna.

The feeding matching circuit 12 and the grounding circuit 14 provided in the present invention can adjust a low-frequency resonance frequency, and high-frequency and low-frequency impedance matching that are of the loop-shaped antenna 10, so as to improve frequency bandwidth of the loop-shaped antenna 10.

The feeding matching circuit 12 includes the feeding end 122, the variable capacitor C1, a second inductor L2, and a third inductor L1, where the second inductor L2 is connected between the feeding end 122 and the variable capacitor C1, and the third inductor L1 is connected between the variable capacitor C1 and the ground. Specifically, the variable capacitor C1 includes a first end and a second end, where the first end of the variable capacitor C1 is connected to the second inductor L2, the second end of the variable capacitor C1 is connected to the radiation portion 16, and the second inductor L1 is connected between the second end and the ground. The variable capacitor C1 of the feeding matching circuit 12 adjusts a frequency of the loop-shaped antenna 10, which facilitates an operation and implementation of an adjustment function.

The mobile terminal 100 includes a circuit board 30, and the feeding matching circuit 12 and the grounding circuit 14 are arranged on the circuit board 30. Positions of the feeding matching circuit 12 and the grounding circuit 14 on the circuit board 30 may be arranged according to a specific layout structure of the circuit board 30, and disposed at any positions of the circuit board 30. The feeding matching circuit 12 and the grounding circuit 14 are connected to the radiation portion 16 by using a straight line on the circuit board 30. In this implementation manner, the feeding matching circuit 12 and the grounding circuit 14 are disposed, side by side, on a position close to an edge of the circuit board 30, and such a layout can shorten a distance between the feeding matching circuit 12 and the radiation portion 16, and a distance between the grounding circuit 14 and the radiation portion 16, thereby reducing a loss of the loop-shaped antenna 10. In conclusion, in the present invention, the feeding matching circuit 12 and the grounding circuit 14 are designed by using space of an edge of the circuit board 30, and the radiation portion 16 of the loop-shaped antenna 10 is outside the circuit board 30 (that is, the radiation portion 16 is not carried on the circuit board 30); such design can effectively save space of the mobile terminal 100 and helps development of light and thin products. In another implementation manner, the radiation portion 16 may be carried on an insulation layer of the circuit board 30, that is, a part of the circuit board 30 on which the radiation portion 16 is carried is a metal-free layer.

The metal back cover 20 is electrically connected to a ground of the circuit board 30. A gap exists between the circuit board 30 and the metal back cover 20, and the gap forms a resonant cavity, which affects performance of an antenna (including the loop-shaped antenna 10 provided in the present invention) inside the mobile terminal 100. In the present invention, grounding of the metal back cover 20 can reduce impact, caused by the gap between the circuit board 30 and the metal back cover 20, on the loop-shaped antenna 10. A manner of grounding of the metal back cover 20 includes that: a grounding pin is added to an inner surface of the metal back cover 20 and the grounding pin extends to be in contact with a ground of the circuit board 30, or a grounding spring is disposed between the metal back cover 20 and a ground of the circuit board 30.

The radiation portion 16 is of a three-dimensional structure and includes a first radiation section 161, a second radiation section 162, a third radiation section 163, a fourth radiation section 164, and a fifth radiation section 165, where the first radiation section 161, the second radiation section 162, the third radiation section 163, the fourth radiation section 164, and the fifth radiation section 165 are successively connected in a sequence. The mobile terminal 100 includes a bottom surface, a pair of side surfaces, and a front surface, and the mobile terminal 100 is of a hexahedron structure, where the front surface is used to dispose a screen of the mobile terminal 100, the bottom surface is connected between the front surface and the metal back cover 20, and the pair of side surfaces are separately located on two sides of the bottom surface and are connected between the front surface and the metal back cover 20. The first radiation section 161 and the fifth radiation section 165 have a same structure, and are located on the bottom surface of the mobile terminal 100; the second radiation section 162 and the fourth radiation section 164 are separately located on the pair of side surfaces; and the third radiation section 163 is located on the front surface of the mobile terminal 100. The radiation portion 16 is arranged on four different surfaces, so that bottom space of the mobile terminal 100 is effectively utilized and radiation performance of the loop-shaped antenna 10 is improved. When a part, in which the loop-shaped antenna 10 is located, of the mobile terminal 100 is held by a hand, radiation performance of the loop-shaped antenna 10 is balanced and consistent between a left and a right hand. Specifically, the loop-shaped antenna 10 provided in the present invention is of a symmetrical or approximately symmetrical structure, current distribution and radiation characteristics of symmetric positions are the same. If a position, at which the left hand holds the mobile terminal 100, of the loop-shaped antenna 10 of the mobile terminal 100 and a position, at which the right hand holds the mobile terminal 100, of the loop-shaped antenna 10 of the mobile terminal 100 are symmetrical, impact on performance of the loop-shaped antenna 10 is consistent; therefore, radiation performance of the loop-shaped antenna 10 is balanced and consistent between the left and the right hand.

The radiation portion 16 is formed on an insulation medium 40; the insulation medium is fixed on a housing of the mobile terminal 100, or the insulation medium may be fixed on a mainboard inside the mobile terminal 100. The insulation medium 40 is of a cuboid structure or of a hexahedron structure of a similar shape, and the radiation portion 16 extends on four adjacent end faces of the insulation medium 40. The insulation medium 40 may be a substantive structure, such as an insulated plastic block. The insulation medium 40 may be air, and when the insulation medium 40 is air, it is equivalent to that the radiation portion 16 is in a overhanging state.

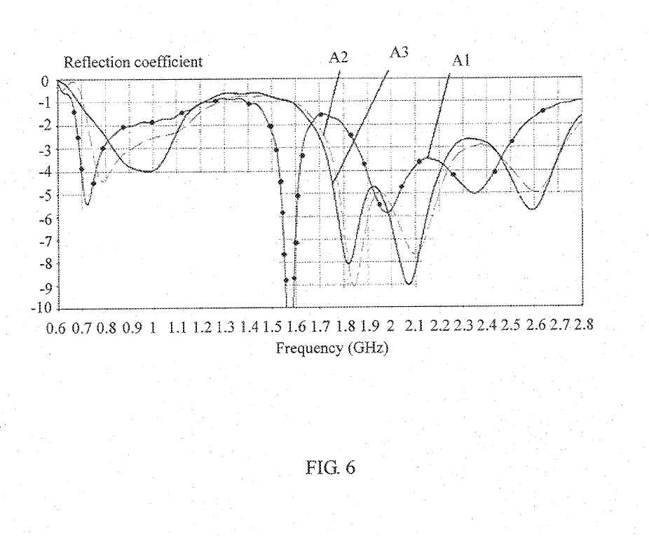

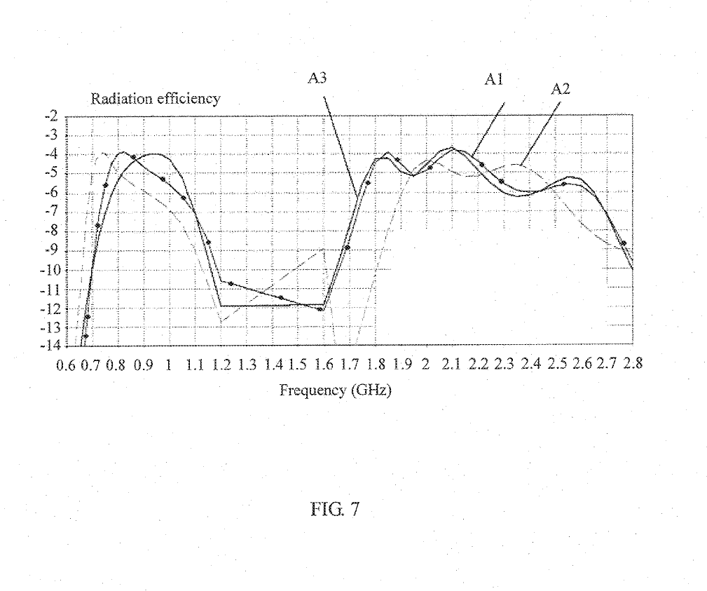

According to the loop-shaped antenna 10 provided in the present invention, two low-efficiency resonances can cover 700 to 960 MHz, and three high-frequency resonances can cover 1710 to 2690 MHz, as shown in FIG. 6 and FIG. 7.

Curve A1 indicates that: a switch component D is open (or a diode does not conduct), a current on the loop-shaped antenna 10 flows through the first inductor L3 to the ground (a value of the first inductor L3 is 6 nH), a variable capacitor C1 of a matching circuit works in a state of C1=2.1 pF. In this case, a low frequency of the loop-shaped antenna 10 works in a frequency band of 700M, and a high frequency covers a frequency band of 1500M, but cannot cover a frequency band of 1710M to 2690M.

Curve A2 indicates that: the switch component D is closed (or a diode conducts). In this case, the first inductor L3 is short-circuited, a current flows through the switch component D to the ground, the variable capacitor of a matching circuit works in a state of C1=2.1 pF, a low frequency of the loop-shaped antenna 10 works in a frequency band of 800M, and a high frequency covers a frequency band of 1710 to 2690M.

Curve A3 indicates that: the switch component D is closed (or a diode conducts). In this case, the first inductor L3 is short-circuited, a current flows through the switch component D to the ground, the variable capacitor of a matching circuit works in a state of C1=3 pF, a low frequency of the loop-shaped antenna 10 works in a frequency band of 900M, and a high frequency covers a frequency band of 1710 to 2690M.

By using a closed state or an open state of the switch component D and variation of the variable capacitor C1 of a matching circuit, the loop-shaped antenna 10 can cover a low-frequency band of 698 to 960M and high-frequency bands of 1500M and 1710 to 2690M, that is, full frequency band coverage of LTE is implemented.

The loop-shaped antenna and the mobile terminal provided in the embodiments of the present invention are described in detail above. The principle and implementation of the present invention are described herein through specific examples. The description about the embodiments of the present invention is merely provided to help understand the method and core ideas of the present invention. In addition, a person of ordinary skill in the art can make variations and modifications to the present invention in terms of the specific implementations and application scopes according to the ideas of the present invention. Therefore, the content of specification shall not be construed as a limit to the present invention.

1-14. (canceled)

15. A loop-shaped antenna, disposed in a mobile terminal, wherein the mobile terminal comprises a metal back cover, and the metal back cover at least partially covers the loop-shaped antenna, wherein the loop-shaped antenna comprises:
a feeding matching circuit,
a grounding circuit, and
a radiation portion,
wherein:
the radiation portion is connected between the feeding matching circuit and the grounding circuit, and the radiation portion is of a symmetrical loop-shaped structure;
the grounding circuit comprises a switch component and a first inductor, wherein the switch component and the first inductor are connected in parallel and between a ground and the radiation portion;
the feeding matching circuit comprises a feeding end and a variable capacitor, wherein the variable capacitor is connected between the feeding end and the radiation portion; and
the feeding matching circuit is configured to adjust impedance matching of the loop-shaped antenna, and the grounding circuit is configured to adjust a resonance frequency of the loop-shaped antenna.

16. The loop-shaped antenna according to claim 15, wherein the feeding matching circuit further comprises a second inductor and a third inductor, wherein the second inductor is connected between the feeding end and a first end of the variable capacitor, and the third inductor is connected between a second end of the variable capacitor and the ground.

17. The loop-shaped antenna according to claim 15, wherein the mobile terminal comprises a circuit board, and the feeding matching circuit and the grounding circuit are arranged on the circuit board.

18. The loop-shaped antenna according to claim 17, wherein the feeding matching circuit and the grounding circuit are disposed, side by side, on a position close to an edge of the circuit board.

19. The loop-shaped antenna according to claim 17, wherein the metal back cover is electrically connected to the ground of the circuit board.

20. The loop-shaped antenna according to claim 15, wherein the radiation portion is of a three-dimensional structure and comprises a first radiation section, a second radiation section, a third radiation section, a fourth radiation section, and a fifth radiation section,
wherein:
the first radiation section, the second radiation section, the third radiation section, the fourth radiation section, and the fifth radiation section are successively connected in a sequence;
the mobile terminal comprises a bottom surface, a pair of side surfaces, and a front surface, and the mobile terminal is of a hexahedron structure, wherein the front surface is configured to dispose a screen of the mobile terminal;
the bottom surface is connected between the front surface and the metal back cover; the pair of side surfaces are separately located on two sides of the bottom surface and are connected between the front surface and the metal back cover;
the first radiation section and the fifth radiation section have a same structure, and are located on the bottom surface of the mobile terminal;
the second radiation section and the fourth radiation section are separately located on the pair of side surfaces; and
the third radiation section is located on the front surface of the mobile terminal.

21. The loop-shaped antenna according to claim 15, wherein the radiation portion is formed on an insulation medium, the insulation medium is fixed on a housing of the mobile terminal, the insulation medium is of a cuboid structure, and the radiation portion extends on four adjacent end faces of the insulation medium.

22. A mobile terminal, comprising;
a metal back cover: and
a loop-shaped antenna, wherein the metal back cover at least partially covers the loop-shaped antenna, and the loop-shaped antenna comprises a feeding matching circuit, a grounding circuit, and a radiation portion,
wherein:
the radiation portion is connected between the feeding matching circuit and the grounding circuit, and the radiation portion is of a symmetrical loop-shaped structure;
the grounding circuit comprises a switch component and a first inductor, wherein the switch component and the first inductor are connected in parallel and then are connected between a ground and the radiation portion;
the feeding matching circuit comprises a feeding end and a variable capacitor, wherein the variable capacitor is connected between the feeding end and the radiation portion; and
the feeding matching circuit is configured to adjust impedance matching of the loop-shaped antenna, and the grounding circuit is configured to adjust a resonance frequency of the loop-shaped antenna.

23. The mobile terminal according to claim 22, wherein the feeding matching circuit further comprises a second inductor and a third inductor, wherein the second inductor is connected between the feeding end and a first end of the variable capacitor, and the third inductor is connected between a second end of the variable capacitor and the ground.

24. The mobile terminal according to claim 22, wherein the mobile terminal further comprises a circuit board, and the feeding matching circuit and the grounding circuit are arranged on the circuit board.

25. The mobile terminal according to claim 24, wherein the feeding matching circuit and the grounding circuit are disposed, side by side, on a position close to an edge of the circuit board.

26. The mobile terminal according to claim 25, wherein the metal back cover is electrically connected to a ground of the circuit board.

27. The mobile terminal according to claim 22, wherein
the radiation portion is of a three-dimensional structure and comprises a first radiation section, a second radiation section, a third radiation section, a fourth radiation section, and a fifth radiation section, wherein the first radiation section, the second radiation section, the third radiation section, the fourth radiation section, and the fifth radiation section are successively connected in a sequence;
the mobile terminal comprises a bottom surface, a pair of side surfaces, and a front surface, and the mobile terminal is of a hexahedron structure, wherein the front surface is configured to dispose a screen of the mobile terminal;
the bottom surface is connected between the front surface and the metal back cover;
the pair of side surfaces are separately located on two sides of the bottom surface and are connected between the front surface and the metal back cover;
the first radiation section and the fifth radiation section have a same structure, and are located on the bottom surface of the mobile terminal;
the second radiation section and the fourth radiation section are separately located on the pair of side surfaces; and
the third radiation section is located on the front surface of the mobile terminal.

28. The mobile terminal according to claim 22, wherein the radiation portion is formed on an insulation medium, the insulation medium is fixed on a housing of the mobile terminal, the insulation medium is of a cuboid structure, and the radiation portion extends on four adjacent end faces of the insulation medium.
